(19) United States
(12) Patent Application Publication
(10) Pub. No.: US 2010/0161982 A1
(43) Pub. Date: Jun. 24, 2010

(54) HOME NETWORK SYSTEM

(76) Inventors: Bong Jin OH, Daejeon (KR); YU SEOK BAE, Daejeon (KR); Kyeong Deok MOON, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/546,329

(22) Filed: Aug. 24, 2009

(30) Foreign Application Priority Data
Dec. 19, 2008 (KR) 10-2008-0129842

(51) Int. Cl. H04L 9/32; H04L 9/00; G06F 17/00; H04L 9/08

(52) U.S. Cl. 713/168; 380/259; 380/270; 380/281; 380/273; 380/44; 700/90

(57) ABSTRACT

A home network system includes: a plurality of wireless devices cooperated with a home network, each device having a tag attached thereto to identify it; a tag reader for reading tag information from the tag of each wireless device; and a network manager for storing a shared key and identifying each wireless device connected to the home network using the tag information and supporting information exchange between the wireless devices by using the shared key.

### CROSS-REFERENCE(S) TO RELATED APPLICATION(S)

The present invention claims priority of Korean Patent Application No. 10-2008-0129842, filed on Dec. 19, 2008, which is incorporated herein by reference.

### FIELD OF THE INVENTION

The present invention relates to a home network system, and more particularly, to a home network system capable of authenticating wireless devices in a home network by using their tags, which enable a reliable exchange of information between the wireless devices in the home network.

### BACKGROUND OF THE INVENTION

Due to the merit of free movement, wireless devices have exponentially increased in their use. It is also known that recent wireless devices cooperating with home network support protocols such as a wireless LAN, Bluetooth, UWB (Ultra-WideBand) and the like. Herein, a problem in such wireless devices is that they have a weakness in security compared to wired devices. This is because, unlike the wired devices, the wireless devices have characteristics in that signals thereof are sent to devices in all directions arranged in the distance to which the signals can reach. Thus, information from the wireless device may be analyzed by a user with negative purpose of damaging a user of the wireless device, or personal information of the user of the wireless device may be easily exposed to unknown users.

As one of currently known techniques, a wireless device's user manually establishes a session for cooperation and sets a key used to encrypt information for its sharing. In this case, the user needs to have certain degree of knowledge of information appliances. Therefore, users who are unfamiliar with information appliances cannot easily handle them.

For this reason, most of wireless LANs that have been widely used in recent years make a connection between an access point (which is a device allowing a wireless LAN to cooperate with wired devices) and a session by automatic search. In fact, however, they do not establish an encryption scheme and key for protection of important information, and thus often cause leakage of information.

In this regard, most users tend to regard, as a bother, a procedure which has to be necessarily taken for secure use of wireless devices, and thus a certificate-based technique has been developed as one of solutions to solve the above problem and is being promoted to be adopted as a standardization technique. For example, sellers issue certification from a certificate authority based on user information when purchasing terminals at retail markets, each of which is issued for respective information appliances. Therefore, terminal's owners can be analyzed by the personal information in the certification. Moreover, even for a wireless device, whether it can cooperate with the users' home network can be automatically recognized by using the certification of the device.

However, the certificate-based technique imposes, on a private or public reliable authority, a burden to manage certifications of all devices and their corresponding user information. Particularly, each device has a possession relation with a specific user, and thus a formal procedure of certificate update is necessary whenever the owner of the device is changed due to rent or transfer of ownership to other people in a real life. To be more specific, in case of the rent or common ownership, complex information such as a right of ownership, right for use (including period in use), and the like for all devices needs to be maintained. Therefore, the amount of information to be managed excessively increases thereby increasing inefficient in costs. In view of users, the formal procedure also has to be taken whenever the common ownership or rent of devices occurs between the users, which results in inconvenience and gives negative image on the certificate-based technique to the users.

### SUMMARY OF THE INVENTION

Therefore, the present invention provides an apparatus and method, which can easily process a session establishment or shared key exchange with minimal user intervention to authenticate wireless devices that can cooperate with a home network and to securely communicate information therebetween.

Further, the invention provides an apparatus and method, which provide a simple and convenient authentication for allowing devices to cooperate with a home network and automates a session establishment or encryption key exchange for information exchange between the devices.

In accordance with a first aspect of the present invention, there is provided a home network system including: a plurality of wireless devices cooperated with a home network, each device having a tag attached thereto to identify it; a tag reader for reading tag information from the tag of each wireless device; and a network manager for storing a shared key and identifying each wireless device connected to the home network using the tag information and supporting information exchange between the wireless devices by using the shared key.

In accordance with a second aspect of the present invention, there is provided: an apparatus for authenticating a wireless device by using a device's tag, including: a device database in which tag information read by a tag reader from a tag attached to a wireless device is registered; a key generator for generating an individual encryption key by encrypting a predetermined shared key by using the read tag information of the device; and a key transmitter for transmitting the generated individual encryption key to the device.

The wireless device decrypts the individual encryption key by using its tag information to obtain the shared key and exchanges information between other devices, which are provided in a home network together with the wireless device, by using the extracted shared key.

In accordance with a third aspect of the present invention, there is provided a method for authenticating each wireless device having a tag attached thereto in a home network system, including: registering tag information provided from a tag attached to a wireless device in a database; generating an individual encryption key by encrypting a predetermined shared key by using the tag information registered in the database; and transmitting the generated individual encryption key to the wireless device.

### BRIEF DESCRIPTION OF THE DRAWINGS

The above and other objects and features of the present invention will become apparent from the following description of embodiments, given in conjunction with the accompanying drawings, in which:

FIG. 1 shows a configuration of a home network system having an authentication apparatus in accordance with an embodiment of the present invention;

FIG. 2 illustrates a flow chart for explaining a device authentication and session establishment process when a new wireless device is added in accordance with the present invention;

FIG. 3 provides a flow chart for explaining a process of exchanging information using a received shared key in accordance with the present invention;

FIG. 4 presents a flow chart for explaining a process of periodically updating a shared key in accordance with the present invention;

FIG. 5 depicts a view illustrating a structure for transmitting and receiving an encrypted shared key between a wireless device and a home server; and

FIGS. 6A to 6D are views illustrating a structure that allows a tag reader to cooperate with a home server, and a tag reader model.

### DETAILED DESCRIPTION OF THE EMBODIMENT

Hereinafter, embodiments of the present invention will be described in detail with reference to the accompanying drawings.

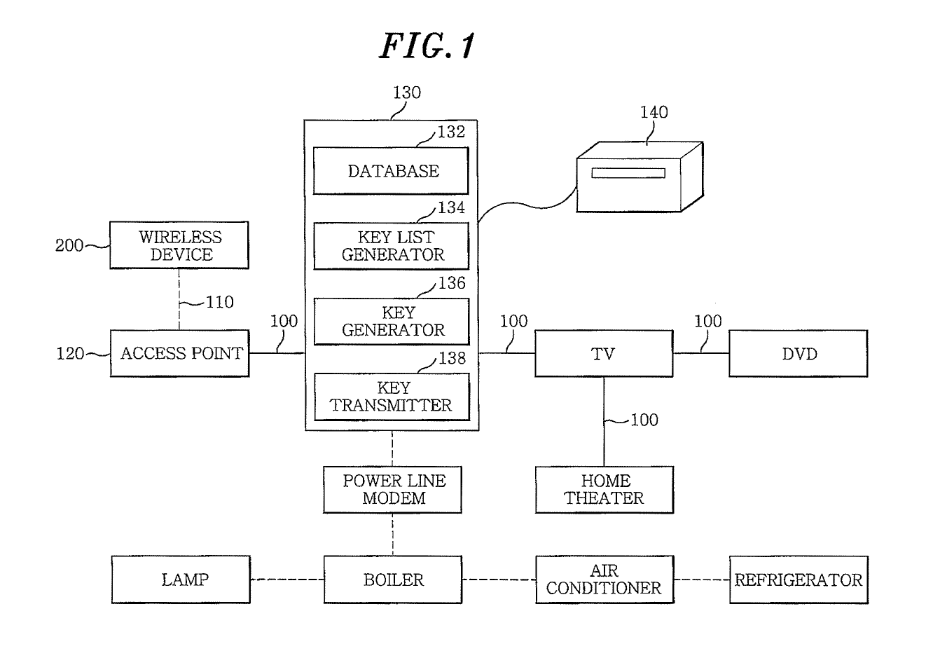

FIG. 1 is a block diagram showing a configuration of a home network having a device authentication apparatus in accordance with the embodiment of the present invention.

The home network shown in FIG. 1 has a configuration in which various information appliances (or devices), such as a wireless notebook, a wireless camera, a home server, TV, DVD, a home theater and on the like are connected through wired/wireless connection media 100 and 110. In this configuration, it is apparent to those skilled in the art that a type of information to be transferred and a transfer mode are determined depending on protocols embedded in each information device and the wired/wireless connection media 100 and 110. Further, an access point 120, such as a wired/wireless sharing device is shown in FIG. 1, through which wired devices can cooperate with wireless devices.

Further, communications may be directly established between wireless information devices, e.g., a wireless notebook and a wireless camera, without passing through the access point 120. In this case, a wireless device transmits a signal of a radio wave through specific frequency channel in the air, and all devices settled to the same frequency channel at the distance to which the signal reaches can receive it.

At this time, a receiving device needs to receive the signal transmitted from the wireless device which is connected to the same home network with a specific authentication. As one example of such authentication, a physically identifiable tag is attached to each wireless device, corresponding tag information is stored in a memory of the wireless device. A physical tag of a specific wireless device is used to authenticate the wireless device as a wireless device involved in a home network, and the identified tag and the tag information stored in the memory of the wireless device utilized as a shared key when establishing security between wireless devices.

Further, referring to FIG. 1, there is a home server 130 which manages the entire home network. The home server 130 is disposed in a user's space like a living room, or at a wall of inner/outer portion of the front door to serve as a gateway. The gateway is generally used to receive an in-house Internet signal or broadcast signal from outside and transmit them through wiring.

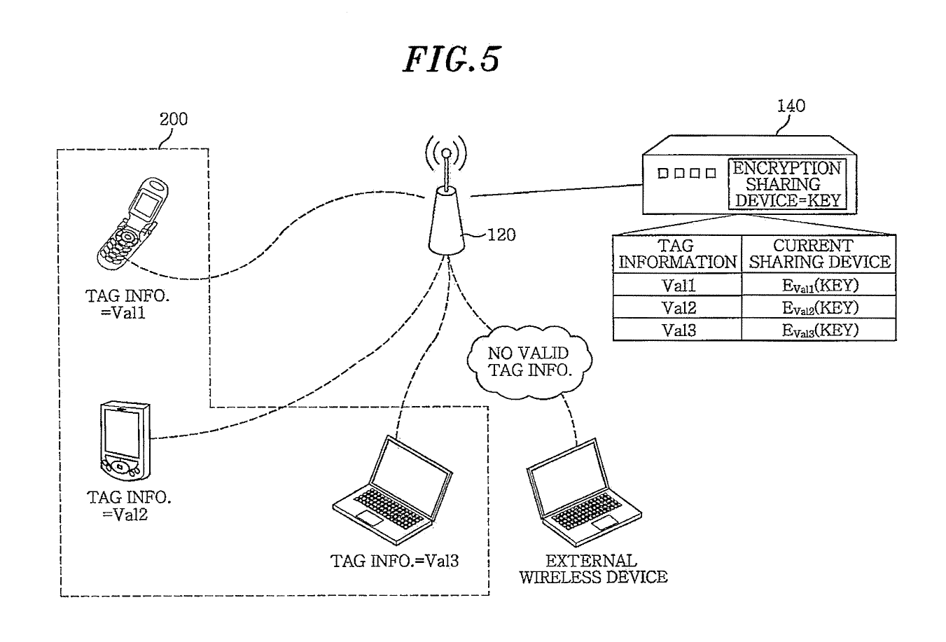

The home server 130 includes a database 132 which stores tag information read by a tag reader 140 from a tag attached to each of wireless devices 200 (wireless devices shown in FIG. 5); and a key list generator 134 for encrypting a predetermined shared key by using each tag information stored in the database 132 to generate a list of encryption keys, each encryption key having tag information. The home server 130 further includes a key generator 136 for generating an individual encryption key by using tag information and shared key upon receipt of tag information from a newly added wireless information device in the home network; and a key transmitter 138 for transmitting the key list or individual encryption key to the wireless device in the home network.

That is to say, when a wireless device is newly added in the home network, the home server 130 itself, or tag reader 140 which cooperates with the home server 130 is utilized to read a physical tag of the newly added wireless device in the home network. Included in the physical tag is unique identifier information assigned to each wireless device. The unique identifier may be, e.g., (manufacturing company, a model number, a serial number, and the like. The tag may be manufactured in the form of hologram, RFID tag and the like.

For convenience, the present invention will be described below by way of an example of a physical tag of a barcode type will be exemplified. That is, tag information of a new device is read by the home server 130 or the tag reader 140 cooperating with the home server 130, and then registered in the database 132 of the home server 130 as a device accessible to the home network.

The home server 130 uses the information registered in the database 132 as a basis for deciding whether the registered device is reliable for information exchange.

The use of tag enables physical authentication of devices in the home network without taking an external certificate authority. Further, people within a same place utilized with the home network can be recognized as those having the right capable of using all devices in the home network, thus requiring no formal authentication procedure when they use the devices. Furthermore, when there is a need for rent or assignment of ownership to other people or a need for device use in a new environment, only a re-registration process by the tag reader 140 is required as long as the authentication procedure using a tag is adopted, thereby giving convenience to the user.

For secure information exchange between wireless devices, a connection of a device to the access point 120 and an encryption setting procedure are necessary. Here, a wireless LAN uses an access point, but a Bluetooth corresponds to a master device. Thus, for the sake of illustration, the device will be referred to as an access point hereinafter.

Such home server 130 stores a common shared key for wireless devices, which may be set and updated by a user on its setting menu. Alternatively, the shared key may be arbitrarily generated by the home server 130 by selecting an auto generation option.

In the present invention, the connection of a new wireless device and encryption setting procedure is automatically performed without manually setting whenever there is an access operation of a new wireless device. Further, the shared key is changed periodically and reported to each wireless device for automatic update, thereby exchanging information more securely.

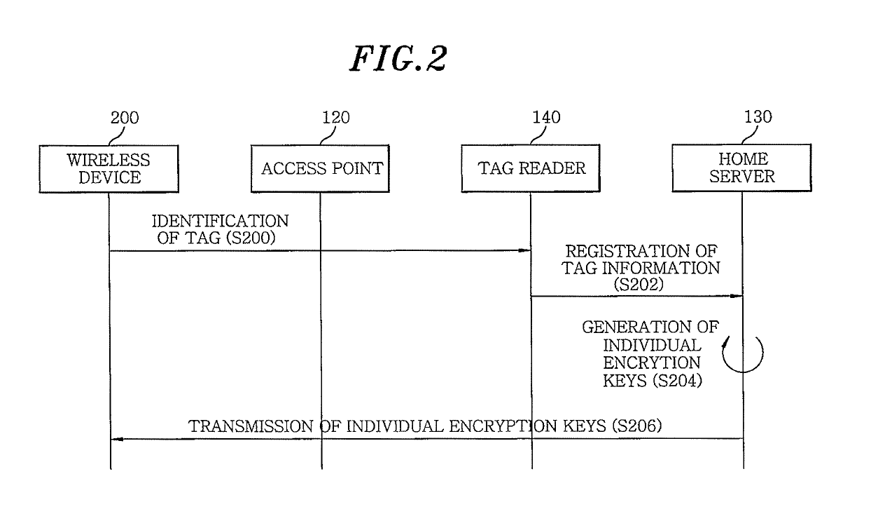

FIG. 2 illustrates a flow chart for explaining a device authentication and session establishment process when a new wireless device is added in accordance with the present invention.

Referring to FIG. 2, when a wireless device 200 is newly added in a home network, then the wireless device 200 transmits a signal to the home server 130 via the access point 120 for wireless connection, and the home server 130 starts a process of transferring a shared key.

To be more specific, first, in step S200, a tag attached to the wireless device 200 is physically identified by the tag reader 140, while transmits tag information, i.e., unique identifier information, to the home server 130 through the access point 120. Then, in step S202, the home server 130 registers the received unique identifier information as tag information in the database 132.

Next, in step S204, the home server 130 encrypts a shared key by using the newly registered tag information to generate an individual encryption key and provides it to the wireless device 200 via the access point 120. Here, an encryption algorithm for encrypting the shared key employs a symmetric key algorithm such as DES, 3DES, AES or the like, wherein an encryption and decryption process are executed with a public key.

Then upon receipt of the encryption key, the wireless device 200 decrypts the individual encryption key by using its tag information, and stores the result in a memory. The shared key stored in the memory is used as a key for encrypting information exchanged between wireless devices.

In this manner, the home server 130 encrypts the shared key using the registered tag information to be deciphered only when a wireless device requesting for connection through the access point 120 identified as one of members registered in the database 132.

In accordance with the present invention, as described above, information using the shared key generated by the home server 130 or selected through the setting menu. Therefore, other wireless device that does not know the shared key cannot decipher packet carrying information although it receives the packet, whereby the reliability of information can be secured. This is because a session ID established between the access point 120 and the wireless device 200 is generally open to the public so that anyone can access thereto, but the shared key made for information exchange is a secret keep.

In accordance with the present invention, the shared key stored in the home server 130 may be changed periodically and updated for new encryption upon access of the existing wireless device 200 thereto.

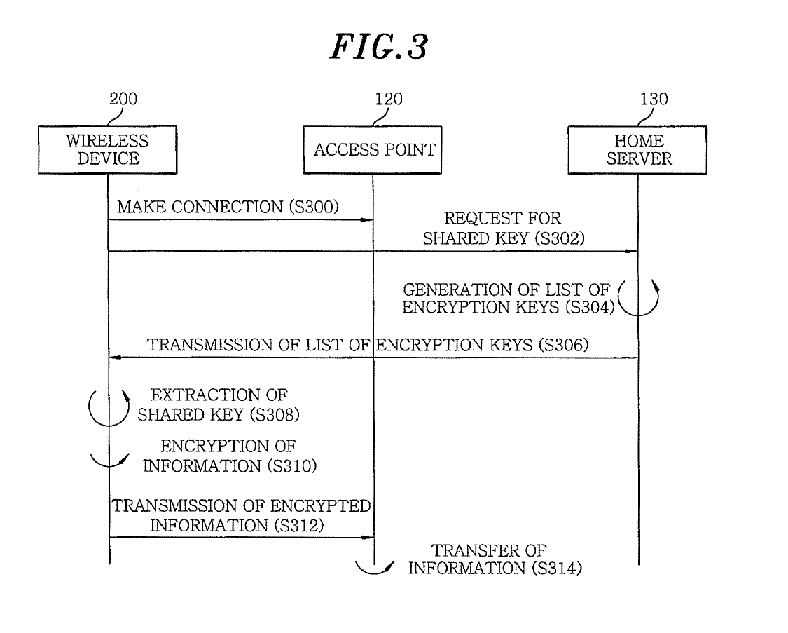

FIG. 3 illustrates a flow chart for explaining a process of exchanging information using a received shared key in accordance with the present invention.

First, referring to FIG. 3, in step S300, when the wireless device 200 changes its power from an off state to an on state, it makes a connection to the access point 120, and in step S302, the wireless device 200 requests the home server 130 for a shared key. Then, in step S304, the home server 130 generates a list of encryption keys by encrypting a latest version of shared key with each tag information registered in the database 132 through the key list generator 134. In step S306, the list of encryption keys so generated are then provided to the wireless device 200 in the home network by the key transmitter 138 via the access point 120.

Subsequently, in step S308, the wireless device 200 selectively extracts an encryption key corresponding to its own tag information from the received list of encryption keys and decrypts the encryption key by using its tag information to obtain the shared key to be used for information exchange. That is, when the wireless device 200 desired to exchange information with other destination devices, it encrypts information to be exchanged by using the shared key in step S310, and then transmits the encrypted information to the access point 120 in step S312.

Next, in step S314, the access point 120 transmits the encrypted information to a destination device to which the wireless device 200 wants to transmit it. In case where the destination device is a wireless device, the access point 120 transmits the encrypted information to the destination device, or when the destination device is a wired device, it decrypts the encrypted information by using the shared key and then transmits the decrypted information to the destination device.

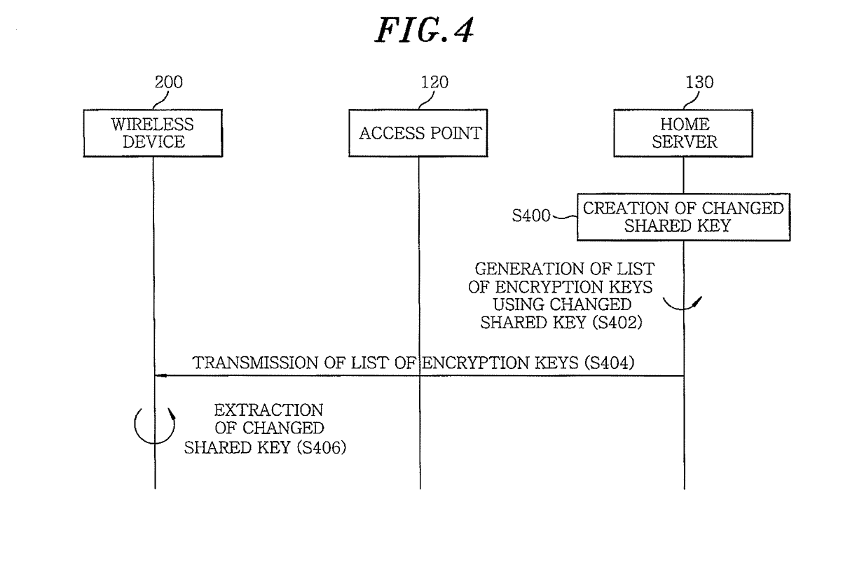

The shared key stored in the home server 130 is changed every predetermined time period. The change of the shared key for the wireless devices 200 under an operation mode is made by the access point 120, details of which will be given with reference to FIG. 4.

FIG. 4 shows a flow chart for explaining a process of periodically updating a shared key in accordance with the present invention.

Referring to FIG. 4, when a changed or new shared key is created in step S400, the home server 130 encrypts the shared key by using the tag information of the wireless device 200 registered in the database 132 and generates a list of encryption keys corresponding to each tag information through the key list generator 134 in step S402, and transmits it to the access point 120 to update the shared key.

Next, in step S404, the access point 120 notifies the wireless devices 200 of the change of the shared key, and transmits the list of encryption keys thereto. Then, in step S406, each of the wireless devices 200 decrypts the shared key by using tag information stored in its memory to extract a changed shared key to be used for information exchange.

Meanwhile, after updating the shared key, when any of the wireless devices 200 changes its power from an off state to an on state, it receives the newly generated shared key through a process shown in FIG. 3.

If there is a method for finding out a shared key in an ill-intended purpose by using a wireless device or an access point, reliability cannot be secured no matter what the encryption algorithm is secure. Therefore, the present invention uses the symmetric key based encryption algorithm which has a feature of preventing leakage of key. FIG. 5 shows a method for sharing a shared key between the home server 130 and the wireless device 200s while preventing leakage of the shared key.

That is, when the wireless device 200 requests the home server 130 to provide the shared key, the home server 130 encrypts the shared key by using each tag information of all wireless devices in the home network, which is a member registered in the database 132, through the key list generator 134 to generate an encryption key for each tag information. The home server 130 transmits a list of encryption keys to the wireless device 200 through the key transmitter 138. The tag information of the wireless device 200 has been already registered and thus the shared key is extracted by decrypting one of the received list of encryption keys with its own tag information.

As such, when the shared key is changed or there is a request for the shared key from the wireless device 200, the list of encryption keys is generated by the key list generator 134 and then transmitted. When the wireless device 200 first makes a connection in the home network, i.e., when tag information is received in the home server 130, an individual encryption key is generated by the key generator 136 and transmitted to the wireless device 200. That is, in the present invention, the list of keys, which is encrypted by using the tag information of all of the wireless devices 200 registered in the device data base 132, is transmitted when the wireless device 200 requests the home server 130 to provide the shared key or when the shared key is changed. Therefore, since tag information is not transmitted for request of the shared key, the possibility of key leakage can be minimized.

As described above, although the list of keys is transmitted, keys used in the open algorithm such as AES or DES are generally 64 bits or 128 bits, which causes a minimum overhead even when transmitting the list of keys including all encryption keys since the number of possible wireless devices in the home network is restricted.

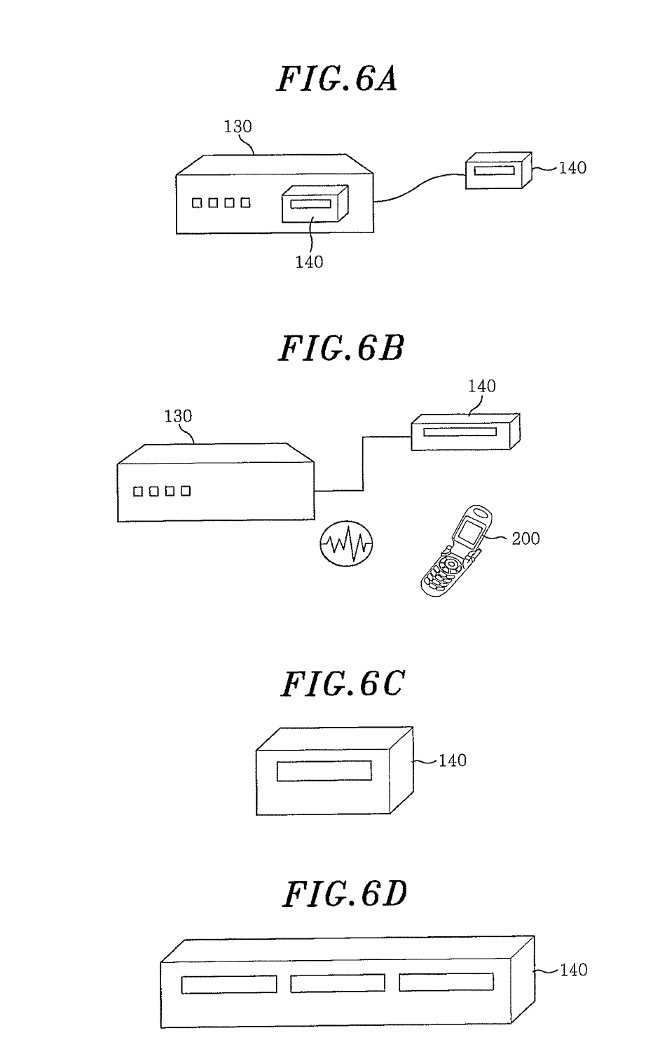

The tag reader 140 used for the present invention is connected as a peripheral device of the home server 130 like a USB reader or embedded in the home server 130 as shown in FIG. 6A. Further, the tag reader 140 may be utilized as a mobile terminal that cooperates with the home network as a separate information appliance or has the function of identifying a barcode or RFID like a mobile phone, as depicted in FIG. 6B.

The tag of the wireless device may be printed in a label form like a barcode to be attached to the outside the device, or may be attached to the device in the form of an electronic circuit identifiable at a given distance as RFID. Thus, the tag reader 140 may be implemented with a single identifier of hologram, barcode, or RFID, as depicted in FIG. 6C, or may be developed in the form of a complex machine to selectively perform an identification process depending on a tag type provided by the device, as shown in FIG. 6D.

Although the present invention has been described with respect to the particular embodiment employing a wireless device, it will be apparent to those skilled in the art that the invention can be applied to any of wired/wireless devices.

As described above, the present invention provides a device with a shared key encrypted by using tag information and encrypts information or authenticates the device by using the shared key. Accordingly, the present invention can easily allow the device to cooperate with a home network by minimizing a user's intervention and also prevent personal information from being infringed in advance by exchange of the encrypted information.

While the invention has been shown and described with respect to the particular embodiments, it will be understood by those skilled in the art that various changes and modification may be made without departing from the scope of the present invention as defined in claims.

What is claimed is:

1. A home network system comprising:
a plurality of wireless devices cooperated with a home network, each device having a tag attached thereto to identify it;
a tag reader for reading tag information from the tag of each wireless device; and
a network manager for storing a shared key and identifying each wireless device connected to the home network using the tag information and supporting information exchange between the wireless devices by using the shared key.

2. The system of claim 1, wherein the network manager comprises:
a database in which tag information read by a tag reader from a tag attached to each wireless device is registered;
a key generator for generating an individual encryption key by encrypting the shared key by using the read tag information of the device; and
a key transmitter for transmitting the generated individual encryption key to the device,
wherein the wireless device decrypts the individual encryption key by using its tag information to obtain the shared key and exchanges information between other devices, which are provided in a home network together with the wireless device, by using the extracted shared key.

3. The system of claim 2, wherein the network manager further including:
a key list generator for, upon receipt of a request for a shared key from the wireless device in the home network, encrypting the predetermined shared key by using each tag information registered in the database to generate a list of encryption keys, and transmitting the generated list of encryption keys to the wireless device through the key transmitter.

4. The system of claim 2, wherein the network manager further including:
a key list generator for, when the shared key is changed, encrypting the changed shared key by using each tag information registered in the database to generate a list of encryption keys, and transmitting the generated list of encryption keys to wireless devices in the home network through the key transmitter.

5. The system of claim 2, wherein the tag includes an RFID, hologram, or barcode.

6. An apparatus for authenticating a wireless device by using a device's tag, comprising:
a device database in which tag information read by a tag reader from a tag attached to a wireless device is registered;
a key generator for generating an individual encryption key by encrypting a predetermined shared key by using the read tag information of the device; and
a key transmitter for transmitting the generated individual encryption key to the device,
wherein the wireless device decrypts the individual encryption key by using its tag information to obtain the shared key and exchanges information between other devices, which are provided in a home network together with the wireless device, by using the extracted shared key.

7. The apparatus of claim 6, further comprising:
a key list generator for, upon receipt of a request for a shared key from the wireless device in the home network, encrypting the predetermined shared key by using each tag information registered in the device database to generate a list of encryption keys, and transmitting the generated list of encryption keys to the wireless device through the key transmitter.

8. The apparatus of claim 6, further comprising:
a key list generator for, when the shared key is changed, encrypting the changed shared key by using each tag information registered in the device database to generate a list of encryption keys, and transmitting the generated list of encryption keys to wireless devices in the home network through the key transmitter.

9. The apparatus of claim 6, wherein the tag attached to the wireless device is generated in the form of an RFID, hologram, or barcode.

10. A method for authenticating each wireless device having a tag attached thereto in a home network system, comprising:
registering tag information provided from a tag attached to a wireless device in a database;
generating an individual encryption key by encrypting a predetermined shared key by using the tag information registered in the database; and
transmitting the generated individual encryption key to the wireless device,
wherein the wireless device decrypts the individual encryption key by using the tag information to extract the shared key and encrypts information exchanged between other devices, which are provided in a home network together with the wireless device, by using the extracted shared key.

11. The method of claim 10, further comprising:
upon receipt of a request for the shared key from the wireless device registered in the database, encrypting the shared key by using each tag information registered in the database to generate a list of encryption keys; and
transmitting the list of encryption keys to wireless devices in the home network,
wherein each of the wireless devices receiving the list of encryption keys extracts an encryption key corresponding to its tag information from the list of encryption keys and decrypts the extracted encryption key by using its tag information to the obtained shared key.

12. The method of claim 10, further comprising:
when the shared key is changed, encrypting the shared key by using each tag information registered in the database to generate a list of encryption keys; and
transmitting the list of encryption keys to wireless devices in the home network,
wherein each of the wireless devices receiving the list of encryption keys extracts an encryption key corresponding to its own tag information from the list of encryption keys and decrypts the extracted encryption key by using its tag information to obtain the shared key.
